(19) United States
(12) Patent Application Publication
(10) Pub. No.: US 2013/0216669 A1
(43) Pub. Date: Aug. 22, 2013

(54) Use of Acidic Polyphosphates in Beverage Products

(71) Applicant: ICL Performance Products LP, (US)

(72) Inventors: Frederick S. Stover, St. Louis, MO (US); Nadeen B. Myers, Wildwood, MO (US); Lirong Zhou, St. Louis, MO (US); David R. Gard, Spokane, WA (US)

(73) Assignee: ICL Performance Products LP, St. Louis, MO (US)

(21) Appl. No.: 13/760,752

(22) Filed: Feb. 6, 2013

Related U.S. Application Data
(60) Provisional application No. 61/595,742, filed on Feb. 7, 2012.

(51) Int. Cl. A23L 2/44

(52) U.S. Cl. CPC A23L 2/44
USPC 426/330.3; 426/532

(57) ABSTRACT

The present invention relates to the use of an acidic polyphosphate in beverage compositions as a preservative, antimicrobial and/or stabilizing agent. One acidic polyphosphate is the acidic polyphosphate sodium acid metaphosphate “SAMP.” Beverages compositions comprising SAMP and methods of making are also provided.

### CROSS-REFERENCE TO RELATED APPLICATIONS

This application claims the benefit of U.S. Provisional Patent Application No. 61/595,742, filed Feb. 7, 2012, which is incorporated herein by reference in its entirety.

### BACKGROUND

Sodium hexametaphosphate (“SHMP”), glassy sodium phosphate, and Graham's salt are common names for a material comprised of a mixture of long chain polyphosphate molecules. SHMP is generally characterized by the average chain length of the material and the sodium-to-phosphorus Na₂O/P₂O₅ (“Na/P”) elemental or mole ratio in the material. The Food Chemical Codex describes sodium hexametaphosphate as:

Sodium Polyphosphates, Glassy, occur as colorless or white transparent platelets, granules, or powders. They belong to a class consisting of several amorphous, water-soluble polyphosphates composed of linear chains of metaphosphate units (NaPO₃)ₓ for which x is greater than or equal to 2, terminated by Na₂PO₄⁻ groups. They are usually identified by their Na₂O/P₂O₅ ratio or their P₂O₅ content. The Na₂O/P₂O₅ ratios vary from about 1.5 for sodium tetrapolyphosphate, for which x is approximately 2, through about 1.1 for Graham's salt, commonly called sodium hexametaphosphate, for which x is 10 to 18; to about 1.0 for the higher molecular weight sodium polyphosphate, for which x is 20 to 100 or more. Glassy sodium polyphosphates are very soluble in water. The pH of their solutions varies from about 3.0 to 9.0.

While the Food Chemicals Codex distinguishes between (i) “sodium hexametaphosphate” as a material with a Na/P ratio of about 1.1 and an average chain length of from 12-20 and (ii) higher molecular weight sodium polyphosphate with an Na/P ratio about 1.0 and an average chain length of 22-100, this distinction is not widely used in practice. Instead, both are commonly referred to as SHMP by those of ordinary skill in the art. These materials have a neutral pH in solution (about pH 5.5 to about pH 8.0).

The use of neutral sodium hexametaphosphate has become popular in the beverage industry as a preservative to control microbial growth (e.g., U.S. Pat. Nos.: 5,431,940, 6,126,980, 6,261,619, 6,265,008, and 6,268,003). It is believed that neutral SHMP indirectly functions as a bacteriostatic agent in a variety of beverages. It is thought that the ability of neutral SHMP to sequester cations may be essential to its antimicrobial properties. The inhibitory mechanism appears to involve interference with divalent cation metabolism leading to cation deficiency, inhibition of cell division, and a loss of cell wall integrity.

### SUMMARY OF THE INVENTION

Certain embodiments of the present invention are drawn to beverage compositions comprising an acidic polyphosphate. The acidic polyphosphate has the general formula:

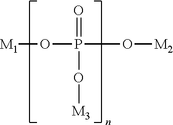

In certain embodiments, n averages from about 25 to about 35, M₁ and M₂ are H atoms, M₃ is independently selected from Na or H, the 1% water solution pH of the acidic polyphosphate is from about pH 3.5 to about pH 4.0, and the acidic polyphosphate has a Na/P molar ratio of <1.0, or the acidic polyphosphate has a Na/P molar ratio of from about 0.95 to about 0.99, or the acidic polyphosphate has a Na/P molar ratio of from about 0.98 to about 0.99. In certain embodiments, the beverage composition comprises from about 625 ppm to about 5000 ppm of the acidic polyphosphate or from about 625 ppm to about 900 ppm of the acidic polyphosphate.

The beverage composition may also further comprise one or more additional preservatives such as benzoate, sorbate, or propionate. For example, in certain embodiments a beverage composition of the invention may comprise: (a) a preservative selected from the group consisting of: from about 0.025% to about 0.1% by weight sorbate, from about 0.125% to about 1.0% by weight propionate, and up to about 0.1% by weight benzoate; (b) from about 625 ppm to about 5000 ppm or from about 625 ppm to about 900 ppm of an acidic polyphosphate as described herein; (c) about 1.25% of a juice concentrate; (d) about 13.38% of 55% high fructose corn syrup; (e) about 0.2% of citric acid monohydrate; and (f) about 85% water; and wherein the beverage composition has a pH of from about pH 3.3 to about pH 3.8.

In certain embodiments of the beverage compositions of the invention, the beverage composition resists microbial growth such that the concentrations of yeasts and molds remain at or below original levels for at least five days at 25° C.

Certain embodiments of the invention are drawn to methods of producing a beverage composition comprising an acidic polyphosphate having the general formula:

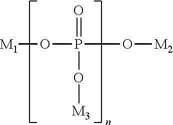

wherein n averages from about 25 to about 35, M₁ and M₂ are H atoms, and M₃ is independently selected from Na or H, wherein the acidic polyphosphate has a Na/P molar ratio of <1.0, and wherein the 1% water solution pH of the acidic polyphosphate is from about pH 3.5 to about 4.0, and wherein the acidic polyphosphate once added is in an amount of from about 625 ppm to about 5000 ppm in the beverage composition. Methods of producing the beverage include adding the acidic polyphosphate to the beverage composition.

### DETAILED DESCRIPTION

### I. Definitions

The following definitions are provided to better define the present invention and to guide those of ordinary skill in the art in the practice of the invention. Unless otherwise noted, terms are to be understood according to conventional usage by those of ordinary skill in the relevant art.

Where a term is provided in the singular, the inventors also contemplate aspects of the invention described by the plural of that term unless otherwise indicated.

Headings are provided herein solely for ease of reading and should not be interpreted as limiting.

The following definitions are provided to better define the present invention and to guide those of ordinary skill in the art in the practice of the invention. Unless otherwise noted, terms are to be understood according to conventional usage by those of ordinary skill in the relevant art.

Where a term is provided in the singular, the inventors also contemplate aspects of the invention described by the plural of that term unless otherwise indicated.

As used herein, “minimum inhibitory concentration (MIC),” is the lowest concentration of an antimicrobial that will inhibit the visible growth of the inoculated microorganism during the incubation period tested.

All weights, parts, and percentages used herein are based on weight unless otherwise specified.

Concentrations, amounts, and other numerical data may be presented here in a range format (e.g., from about 5% to about 20%). It is to be understood that such range format is used merely for convenience and brevity, and should be interpreted flexibly to include not only the numerical values explicitly recited as the limits of the range, but also to include all the individual numerical values or sub-ranges encompassed within that range, as if each numerical value and sub-range is explicitly recited. For example, a range of from about 5% to about 20% should be interpreted to include numerical values such as, but not limited to 5%, 5.5%, 9.7%, 10.3%, 15%, etc., and sub-ranges such as, but not limited to 5% to 10%, 10% to 15%, 8.9% to 18.9%, etc.

### II. Overview

The present invention provides for the improved shelf life of beverage products. For example, in certain embodiments of the invention, a beverage composition of the invention resists microbial growth such that the concentrations of yeasts and molds remain at or below original levels for at least five days at 25° C. The original levels are those that would be present in the beverage at the time the beverage is packaged. It is also contemplated that in addition to controlling yeasts and molds, control of bacterial growth will also be enhanced. More specifically, the present invention provides for the use of an acidic polyphosphate in such products. One such acidic polyphosphate is sodium acidic metaphosphate or “SAMP.” SAMP is physically distinguishable from other glassy sodium phosphates, such as neutral SHMP, due to SAMP's average chain length of approximately 30 and its Na/P ratio of less than about 1.0. By dropping the Na/P ratio to below 1.0 in the feed liquor to the manufacturing furnace, a material is produced with a 1% water solution pH of from about pH 3.5 to about pH 4.0.

It has been discovered that the acidic polyphosphate SAMP exhibits lower minimum inhibitory concentrations (MIC) for yeast and mold in a fruit beverage than typical neutral sodium polyphosphate glasses with a Na/P molar ratio of greater than 1.0 and average chain lengths of from about 10 to 25 (See e.g., Example 1).

SAMP can be used alone or in combination with other preservatives to impart improved preservative performance and shelf life to beverages. Results suggest that there is a synergistic effect between SAMP and other traditionally used beverage preservatives such that lower levels of the preservatives may be employed when SAMP is present. SAMP reduces the risk of benzene formation because SAMP allows for a lower level of benzoate to be used, thus reducing the amount of benzene that can form. Thus it is contemplated that for systems containing benzoate, the use of polyphosphates including SAMP will reduce the formation of benzene.

### III. Sodium Acid Metaphosphate

One aspect of the present invention is drawn to beverage compositions comprising an acidic polyphosphate characterized by the structure of Formula I:

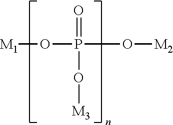

wherein n averages from about 25 to about 35, wherein M₁ and M₂ are H atoms (protons) and M₃ is independently selected from Na or H, and wherein the Na/P molar ratio is <1.0. In certain embodiments, the 1% water solution pH is from about pH 3.5 to about pH 4.0.

In certain embodiments, the beverage compositions comprise an acidic polyphosphate characterized by the structure of Formula I:

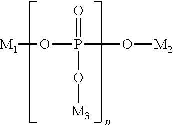

wherein n averages from about 25 to about 35, wherein M₁ and M₂ are H atoms (protons) and M₃ is independently selected from Na or H, and wherein the Na/P molar ratio is from about 0.95 to about 0.99. In certain embodiments, the 1% water solution pH is from about pH 3.5 to about pH 4.0.

In certain embodiments, the beverage compositions comprise an acidic polyphosphate characterized by the structure of Formula I:

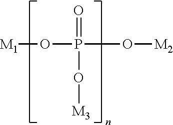

wherein n averages from about 25 to about 35, wherein M₁ and M₂ are H atoms (protons) and M₃ is independently selected from Na or H, and wherein the Na/P molar ratio is from about 0.98 to about 0.99. In certain embodiments, the 1% water solution pH is from about pH 3.5 to about pH 4.0.

SAMP is produced by thermally dehydrating a sodium orthophosphate mixture having a Na/P mole ratio of <1.00. For example, SAMP is produced by thermally dehydrating a sodium orthophosphate mixture having a Na/P mole ratio of from about 0.95 to about 0.99. The heating temperature and time are such that the sodium phosphate is nearly completely dehydrated, yielding a product having an average chain length (n) from about 25 to about 35.

In general, a hot concentrated solution of sodium phosphate is first prepared from phosphoric acid and sodium carbonate. Sodium carbonate may be replaced either partially or completely by sodium hydroxide. The relative amounts of raw materials are such that a Na/P mole ratio of about 0.95 to about 0.99 is achieved. The sodium phosphate solution is then fed continuously to a furnace where water is driven off, dehydrating the sodium phosphate. Temperatures of approximately 650° C. to 900° C. are used to drive the dehydration and to maintain the material in a molten state. The melt exiting the furnace is poured onto a chilling device where it solidifies into a glass. The resultant SAMP glass may then be milled and/or screened.

In certain preferred embodiments, the SAMP is food grade SAMP. The raw materials for producing food grade SAMP are selected to deliver a product that meets food grade specifications such as defined by the Food Chemical Codex or other published standards. Food grade SAMP is produced using manufacturing practices and quality controls to ensure food grade quality, such as but not limited to, the use of Good Manufacturing Practices (GMP), Good Hygiene Practices (GHP), Hazard Analysis Critical Control Point (HACCP), and compliance with regulated purity and physical property specifications (e.g., Food Chemical Codex (FCC) in the U.S.).

### IV. Beverage Compositions Comprising SAMP

It is believed that SAMP is useful in a wide range of beverage product applications. Representative examples of beverages include, but are not limited to, juices, juice drinks, sports drinks, energy drinks, ciders, flavored waters, vitamin waters, punches, ades, and teas, which are generally non-carbonated, although beverages of the invention may be carbonated or non-carbonated. In certain embodiments, the beverage comprises the acidic polyphosphate SAMP of Formula I, wherein the average length of n is from about 25 to about 35, wherein M₁ and M₂ are H atoms (protons) and M₃ is independently selected from Na or H, wherein the Na/P molar ratio is less than 1.0, and wherein the 1% water solution pH is from about pH 3.5 to about pH 4.0. In certain embodiments, the Na/P ratio is from about 0.95 to about 0.99. In certain embodiments, the Na/P ratio is from about 0.98 to about 0.99. In certain embodiments, SAMP is used with at least one preservative, such as but not limited to benzoate, sorbate, and/or propionate, to achieve a synergistic effect that lowers the levels of preservative needed. Representative levels of preservatives include from about 0.025% to about 0.1% sorbate, 0.125% to 1.0% propionate, and up to about 0.1% of benzoate. In certain embodiments, SAMP is used in a system containing benzoate to limit the formation of benzene.

A typical beverage formulation comprising SAMP can be described as having about 0.065% potassium sorbate, about 0.1% SAMP, about 85% water, about 1.25% juice concentrate, about 13.38% of 55% HFCS/Isosweet 5500, and about 0.2% citric acid monohydrate with a beverage pH of about pH 3.3 to about pH 3.8. In a certain preferred embodiment, the juice concentrate is orange juice concentrate (a concentrate is a juice with the majority of water removed). In certain embodiments, SAMP is used in a range of from about 625 ppm to about 5000 ppm. In certain embodiments, SAMP is used in a range of from about 625 ppm to about 2000 ppm. The most effective range of SAMP to inhibit yeast/mold growth in conjunction with potassium sorbate was found to be from about 875 to about 2000 ppm. In certain embodiments, SAMP is used in a range for example of from about 625 ppm to about 1500 ppm, or from about 625 ppm to about 1000 ppm, or from about 875 ppm to about 1500 ppm, or from about 875 ppm to about 1000 ppm, or from about 625 ppm to about 900 ppm.

Certain embodiments of the invention are drawn to methods of making, producing, manufacturing, and the like a SAMP containing beverage composition consistent with the embodiments described herein. Such methods include the addition of SAMP into a beverage composition at levels consistent with those described herein to produce a SAMP containing beverage composition.

### V. Examples

The following disclosed embodiments are merely representative of the invention which may be embodied in various forms. Thus, specific structural, functional, and procedural details disclosed in the following examples are not to be interpreted as limiting.

### Determination of the Minimum Inhibitory Concentrations of Various Antimicrobial Compounds Including SAMP Against Spoilage Organisms in an Orange Juice Drink.

A study was done to determine the minimum inhibitory concentration (“MIC”) of phosphate compounds, including SAMP, along with the preservatives benzoate and sorbate, against yeast, mold, and lactic acid bacteria in a juice drink formulation. These results suggest a synergy between SAMP and the other preservatives such that lower levels of the preservative are needed if SAMP is present.

Juice drink samples were prepared to contain a minimum of five gradually decreasing levels of the test compounds. Positive control samples of each product were also prepared without test compounds. Five replicates were prepared of each sample. Three mixed inocula were prepared from: (i) yeast (Saccharomyces cerevisiae from beer), Rhodotorula ssp. from juice, Candida magnolia from pineapple concentrate and preservative resistant Zygosaccharomyces bailli; (ii) mold Aspergillus niger, Penicillium ssp. from pineapple juice, and Fusarium ssp. from raspberry juice; and (iii) lactic acid bacteria, Lactobacillus plantarum and Lactobacillus ssp. from spoiled tomato paste.

Juice samples were prepared with water adjusted to 80 ppm hardness (as calcium carbonate) and inoculated with a minimum volume of inoculate. Samples were inoculated to approximately 100,000 cfu/ml with the appropriate spoilage organism cocktail. Samples inoculated with yeast and mold were incubated for five days at 25° C. Samples inoculated with lactic acid bacteria were incubated for four days at 35° C. Following the incubation period, samples were examined for turbidity, sediment, or other visible growth as compared to the positive control.

The lactic acid bacteria tested in this test did not grow in the orange juice drink, not even in the positive control, so no minimum inhibitory concentration was determined. The MIC of SAMP was found to be 625 ppm for yeast and 875 ppm for mold. Table 1 shows a comparison of MIC for inhibiting yeast and mold growth of Hexaphos, Glass H, and SAMP in the test orange juice drink.

TABLE 1
MIC for inhibiting yeast and mold growth

| | Mold MIC | Yeast MIC |
|---|---|---|
| Hexaphos | 1000 ppm | 1000 ppm |
| Glass H | 1000 ppm | 625 ppm |
| SAMP | 875 ppm | 625 ppm |

The MIC of SAMP for mold was lower than the MIC for the polyphosphates Hexaphos and Glass H. The MIC of SAMP for yeast was lower than the MIC for Hexaphos but equal to that of Glass H. Table 2 shows the typical values of Na/P mole ratio and chain length that physically distinguish SAMP from other polyphosphates.

TABLE 2

| | Na/P Mole | | Typical 1% water |
|---|---|---|---|
| | Ratio | Chain Length | solution pH |
| Hexaphos | 1.07 | 12 | pH 7 |
| Glass H | 1.01 | 22 | pH 6 |
| SAMP | 0.98-0.99 | 30 | pH 3.8 |

What is claimed is:

1. A beverage composition comprising from about 625 ppm to about 5000 ppm of an acidic polyphosphate SAMP having the formula: 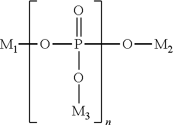
wherein n averages from about 25 to about 35, wherein M₁ and M₂ are H atoms and M₃ is independently selected from Na or H, wherein the acidic polyphosphate has a Na/P molar ratio of <1.0, and wherein the 1% water solution pH of the acidic polyphosphate is from about pH 3.5 to about 4.0.

2. The beverage composition of claim 1 wherein the composition comprises from about 625 ppm to about 900 ppm of the acidic polyphosphate SAMP.

3. The beverage composition of claim 1 wherein the concentrations of yeasts and molds remain at or below original levels for at least five days at 25° C.

4. The beverage composition of claim 1 wherein the acidic polyphosphate SAMP has a Na/P molar ratio of from about 0.95 to about 0.99.

5. The beverage composition of claim 1 wherein the acidic polyphosphate SAMP has a Na/P molar ratio of from about 0.98 to about 0.99.

6. The beverage composition of claim 1 wherein n averages from about 25 to about 30.

7. The beverage composition of claim 1 further comprising at least one additional preservative selected from the group consisting of benzoate, sorbate, and propionate.

8. A beverage composition comprising:
(a) a preservative selected from the group consisting of: from about 0.025% to about 0.1% by weight sorbate, from about 0.125% to about 1.0% by weight propionate, and up to about 0.1% by weight benzoate;
(b) from about 625 ppm to about 5000 ppm of the acidic polyphosphate SAMP having the formula: 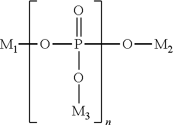
wherein n averages from about 25 to about 35, wherein M₁ and M₂ are H atoms and M₃ is independently selected from Na or H, wherein the acidic polyphosphate has a Na/P molar ratio of <1.0, and wherein the 1% water solution pH of the acidic polyphosphate is from about pH 3.5 to about 4.0;
(c) about 1.25% of a juice concentrate;
(d) about 13.38% of 55% high fructose corn syrup;
(e) about 0.2% of citric acid monohydrate; and
(f) about 85% water;
and wherein the beverage composition has a pH of from about pH 3.3 to about pH 3.8.

9. The beverage composition of claim 8 wherein the composition comprises from about 625 ppm to about 900 ppm of the acidic polyphosphate SAMP.

10. The beverage composition of claim 8 wherein the concentrations of yeasts and molds remain at or below original levels for at least five days at 25° C.

11. The beverage composition of claim 8 wherein the acidic polyphosphate SAMP has a Na/P molar ratio of from about 0.95 to about 0.99.

12. The beverage composition of claim 8 wherein the acidic polyphosphate SAMP has a Na/P molar ratio of from about 0.98 to about 0.99.

13. The beverage composition of claim 8 wherein n averages from about 25 to about 30.

14. A method of producing a beverage composition, the method comprising adding to the beverage composition an acidic polyphosphate SAMP having the formula: 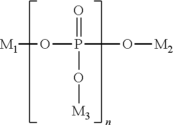
wherein n averages from about 25 to about 35, wherein M₁ and M₂ are H atoms and M₃ is independently selected from Na or H, wherein the acidic polyphosphate has a Na/P molar ratio of <1.0, wherein the 1% water solution pH of the acidic polyphosphate is from about pH 3.5 to about 4.0, and wherein the acidic polyphosphate once added is in an amount of from about 625 ppm to about 5000 ppm in the beverage composition.

15. The method of claim 14 wherein the composition comprises from about 625 ppm to about 900 ppm of the acidic polyphosphate SAMP,

16. The method of claim 14 wherein the concentrations of yeasts and molds remain at or below original levels for at least five days at 25° C.

17. The method of claim 14 wherein the acidic polyphosphate SAMP has a Na/P molar ratio of from about 0.95 to about 0.99.

18. The method of claim 14 wherein the acidic polyphosphate SAMP has a Na/P molar ratio of from about 0.98 to about 0.99.

19. The method of claim 14 wherein n averages from about 25 to about 30.

20. The method of 4 claim 14 further comprising adding at least one additional preservative selected from the group consisting of from about 0.025% to about 0.1% by weight sorbate, from about 0.125% to about 1.0% by weight propionate, and up to about 0.1% by weight benzoate.
